(19) United States
(12) Patent Application Publication
(10) Pub. No.: US 2025/0069407 A1
(43) Pub. Date: Feb. 27, 2025

(54) METHOD AND SYSTEM FOR MONITORING A VEHICLE ENVIRONMENT

(71) Applicant: ZF FRIEDRICHSHAFEN AG, Friedrichshafen (DE)

(72) Inventors: Matthias RUEBER, Oberteuringen (DE); Sami AHMED, Friedrichshafen (DE); Peter HERZOG, Baienfurt (DE)

(21) Appl. No.: 18/721,889

(22) PCT Filed: Nov. 23, 2022
(86) PCT No.: PCT/EP2022/082998

§ 371 Date: Jun. 20, 2024

(30) Foreign Application Priority Data
Dec. 22, 2021 (DE) 10 2021 214 883.2

(51) Int. Cl. G06V 20/56

(52) U.S. Cl. CPC G06V 20/56

(57) ABSTRACT

A method for detecting an object in the environment of a vehicle by way of an environment detection sensor system arranged on the vehicle, the method including establishing a monitoring region in a detection region of the environment detection sensor system in order to monitor the environment of the vehicle for an object residing in the monitoring region by way of the environment detection sensor system. The method further includes locally determining a measurement deviation for at least one measurement value of the environment detection sensor system in the established monitoring region and locally adjusting a region boundary of the established monitoring region in line with the locally determined measurement deviation in order to monitor the environment of the vehicle for the object residing in the adjusted monitoring region by way of the environment detection sensor system.

### CROSS REFERENCE TO RELATED APPLICATIONS

This application is a U.S. National Phase application under 35 U.S.C. § 371 of International Application No. PCT/EP2022/082998, filed on Nov. 23, 2022, and claims benefit to German Patent Application No. DE 10 2021 214 883 0.2, filed on Dec. 22, 2021. The International Application was published in German on Jun. 29, 2023 as WO 2023/117278 A1 under PCT Article 21(2).

### FIELD

The present invention relates to a method and a system for detecting an object in the environment of a vehicle.

### BACKGROUND

It is known from the prior art to detect objects in the environment of a vehicle by way of an environment detection sensor system arranged on the vehicle. Environment detection of this kind can form a basis for a driver assistance system or automated operation of the vehicle. However, the object detection by way of an environment detection sensor may involve measurement uncertainties which may render decisions based on the object detection for operating a vehicle unreliable.

It is known from WO 2018/045055 A1 to determine a possible intersection path of the object with a vehicle on the basis of an object detected in a vehicle environment, in order to avoid a possible collision of the vehicle with the object.

### SUMMARY

In an embodiment, the present disclosure provides a method for detecting an object in the environment of a vehicle by way of an environment detection sensor system arranged on the vehicle, the method comprising establishing a monitoring region in a detection region of the environment detection sensor system in order to monitor the environment of the vehicle for an object residing in the monitoring region by way of the environment detection sensor system. The method further comprises locally determining a measurement deviation for at least one measurement value of the environment detection sensor system in the established monitoring region and locally adjusting a region boundary of the established monitoring region in line with the locally determined measurement deviation in order to monitor the environment of the vehicle for the object residing in the adjusted monitoring region by way of the environment detection sensor system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a vehicle and a system according to an embodiment of the invention;

FIG. 2 shows a local determination of measurement deviations;

FIG. 3 shows a further local determination of measurement deviations;

FIG. 4 shows a local adjustment of a monitoring region according to an embodiment;

FIG. 5 shows a further local adjustment of a monitoring region according to an embodiment; and

FIG. 6 shows a flowchart of method steps for detecting an object in the environment of a vehicle according to an embodiment of the invention.

### DETAILED DESCRIPTION

In an aspect, the present invention relates to a method for detecting an object in the environment of a vehicle by way of an environment detection sensor system arranged on the vehicle.

The vehicle can in principle be any vehicle, for example a non-rail-bound vehicle or a rail-bound vehicle. The vehicle can be a road user. According to an embodiment, the vehicle is a commercial vehicle, for example a truck. In the case of the commercial vehicle, monitoring an environment of the commercial vehicle for an object residing in this environment can be a stipulated prerequisite for operating the commercial vehicle.

The environment of the vehicle can comprise at least one spatial region of the surroundings of the vehicle. The spatial region can be a two-dimensional spatial region, for example a horizontal or vertical plane, or be a three-dimensional spatial region in the surroundings of the vehicle. The object can be a stationary object or a dynamic object in the environment of the vehicle. The object can be a road user residing in the environment of the vehicle in a stationary or dynamic manner. The object can, for example, be another vehicle, a pedestrian or a piece of street furniture.

The environment detection sensor system can have at least one detection sensor. The environment detection sensor system or the detection sensor can have at least one of a distance-measuring sensor and an image-capturing sensor. The distance-measuring sensor can be in the form of a scanning sensor. The distance-measuring sensor can, for example, be a radar measuring device, a laser scanner or an ultrasonic measuring device. The image-capturing sensor can be in the form of a camera.

As one step, the method comprises establishing a monitoring region in a detection region of the environment detection sensor system. The step of establishing the monitoring region is carried out in order to monitor the environment of the vehicle for an object residing in the monitoring region by way of the environment detection sensor system. The method can also have the step of monitoring the environment of the vehicle for an object residing in the monitoring region by way of the environment detection sensor system. In yet a further step of the method, it is possible to establish whether an object detected by the environment detection sensor system is located in the monitoring region.

The detection region can be a region in the environment of the vehicle in which the environment detection sensor system is able to detect an object. The detection region can therefore be a measuring region in which the environment detection sensor system is able to generate a measurement value relating to the object. The detection region can be limited by at least one angle measurement region of the environment detection sensor system. Alternatively or in addition, the detection region can be limited by at least one distance measurement region of the environment detection sensor system. The monitoring region can be in the form of a subregion of the detection region in the latter. The monitoring region can therefore be established in the detection region and relative to the vehicle. According to an embodiment, the monitoring region is formed lateral to the vehicle in the direction of travel of the vehicle.

As a further step, the method comprises locally determining a measurement deviation for at least one measurement value of the environment detection sensor system in the established monitoring region. The measurement deviation can be locally determined for at least one measurement value of the environment detection sensor system on a region boundary of the established monitoring region. Alternatively or in addition, the measurement deviation can be locally determined for at least one measurement value of the environment detection sensor system in a subregion of the established monitoring region. The measurement deviation can illustrate or be based on a measurement uncertainty for the measurement value of the environment detection sensor system.

Embodiments of the invention are based on the knowledge that measurement deviations for measurement values of the environment detection sensor system can vary significantly in the established monitoring region. Measurement deviations can thus deviate significantly from one another in dependence on associated measurement values in different subregions of the monitoring region. A locally determined measurement deviation can depend on the relative position of an object detected by the environment detection sensor system in relation to the latter. The relative position of the detected object can comprise a relative position of the object in relation to the environment detection sensor system. The measurement deviation can therefore be a position deviation of a detected position of the object in relation to a setpoint position of the object. The relative position of the detected object can also comprise a relative orientation of the object in relation to the environment detection sensor system. The locally determined measurement deviation can depend on at least one of an angle measurement and a distance measurement of the environment detection sensor system in relation to an object residing in the environment of the vehicle.

As a further step, the method comprises locally adjusting a region boundary of the established monitoring region in line with the locally determined measurement deviation. The step of the local adjustment is carried out in order to monitor the environment of the vehicle for an object residing in the adjusted monitoring region by way of the environment detection sensor system. As a further step, the method can comprise monitoring the environment of the vehicle for an object residing in the adjusted monitoring region by way of the environment detection sensor system.

Locally adjusting the region boundary can comprise locally extending the region boundary on the basis of the locally determined measurement deviation. Locally adjusting the region boundary can thus comprise locally extending the region boundary by the locally determined measurement deviation. Furthermore, alternatively or in addition to the local extension, the local adjustment of the region boundary can also comprise locally narrowing the region boundary on the basis of the locally determined measurement deviation.

Embodiments of the invention are also based on the knowledge that, for measurement-reliable object detection in the monitoring region, it can be sufficient to locally adjust a spatial extent of the established monitoring region in line with spatially varying measurement deviations of the environment detection sensor system. The monitoring region can therefore be locally enlarged on the basis of the locally determined measurement deviation in order to ensure reliable object detection in the monitoring region. The locally adjusted monitoring region can therefore be a locally enlarged monitoring region compared to the established monitoring region.

Embodiments of the invention can be used to locally adjust a monitoring region of an environment detection sensor system in line with spatially varying measurement deviations of the environment detection sensor system. The adjusted monitoring region can have a certainty region which can be arranged around the region boundary of the established monitoring region. The established monitoring region and the certainty region can form the adjusted monitoring region. Local extension of the certainty region corresponds to local measurement deviations. The certainty region can thus be extended along the region boundary of the established monitoring region in dependence on the locally determined measurement deviation. The certainty region can therefore form a locally varying certainty band around the established monitoring region.

An advantageous effect of an embodiment of the invention can be that falsely positive object detections by the environment detection sensor system, that is to say detected objects assigned to the monitoring region but which in reality are located outside the monitoring region, can be minimized. The advantageous effect can be based on the fact that the monitoring region is locally extended only to the extent that is required by the local measurement deviation or the local measurement uncertainty of the environment detection sensor system in order to also assign a detected object to the monitoring region with a specified certainty.

According to an embodiment of the method, in the step of locally determining the measurement deviation, the measurement deviation can be locally determined for the measurement value on the basis of an angle measurement error of the environment detection sensor system. The measurement deviation can be a corresponding distance-dependent measurement deviation. The measurement value can comprise an angle measurement in relation to an object or a position determination of the object which can comprise the angle measurement error. The angle measurement error can be locally determined in dependence on a measurement distance in relation to the object. The measurement deviation can therefore be a measurement uncertainty for an angle measurement or for a position determination by the environment detection sensor system. The measurement uncertainty can be a distance-dependent measurement uncertainty. The angle measurement or the measurement value can relate to a measured angle in relation to the object or relate to a measured position of the object in a sensor coordinate system of the environment detection sensor system. The measurement deviation or the angle measurement error can comprise random angle measurement errors, for example a normally distributed angle measurement error. Alternatively or in addition, the measurement deviation or the angle measurement error can comprise a systematic angle measurement error, for example based on an incorrect calibration of the environment detection sensor system.

According to an embodiment of the method, in the step of locally determining the measurement deviation, the measurement deviation can be locally determined for the measurement value on the basis of a distance measurement error of the environment detection sensor system. The measurement deviation can be a corresponding distance-dependent measurement deviation. The measurement value can comprise a distance measurement in relation to the object or a position determination of the object which can comprise the distance measurement error. The distance measurement error can be locally determined in dependence on a measurement distance in relation to the object. The measurement deviation can therefore be a measurement uncertainty for a distance measurement or for a position determination by the environment detection sensor system. The measurement uncertainty can be a distance-dependent measurement uncertainty. The distance measurement or the measurement value can relate to a measured distance in relation to the object or relate to a measured position of the object in a sensor coordinate system of the environment detection sensor system. The measurement deviation or the distance measurement error can comprise random distance measurement errors, for example a normally distributed distance measurement error. Alternatively or in addition, the measurement deviation or the distance measurement error can comprise a systematic distance measurement error, for example based on an incorrect calibration of the environment detection sensor system.

According to an embodiment of the method, in the step of locally determining the measurement deviation, the measurement deviation can be locally determined on the basis of predetermined technical data of the environment detection sensor system. The data can be operating data of the sensor. The predetermined technical data can comprise manufacturer-specific data about measurement deviations of the environment detection sensor system. The predetermined technical data can comprise measurement deviations of the environment detection sensor system in dependence on a distance, measured by the environment detection sensor system, in relation to an object, an angle, measured by the environment detection sensor system, in relation to an object, or a position, measured by the environment detection sensor system, of an object.

According to an embodiment of the method, in the step of locally determining the measurement deviation, the measurement deviation can be locally determined on the basis of an empirical test of the environment detection sensor system for detecting the object in the environment of the vehicle. The empirical test can comprise comparing a measured distance in relation to a test object, a measured angle in relation to a test object, or a measured position of a test object in the monitoring region, with a corresponding setpoint variable. The empirical test can thus comprise, for example, comparing a measured position of the test object with a setpoint position. The locally determined measurement deviation can be derived from the comparison which can be a setpoint/actual comparison. When the empirical test is being carried out, the test object can be located on the region boundary of the established monitoring region. The measurement deviation can therefore be locally determined on the region boundary.

According to an embodiment of the method, in the step of locally determining the measurement deviation, a measurement deviation for at least one measurement value of the environment detection sensor system can be locally determined along the region boundary of the established monitoring region. The measurement deviation can be locally determined along the region boundary on the basis of the angle measurement error. Alternatively or in addition, the measurement deviation can be locally determined along the region boundary on the basis of the distance measurement error. Further alternatively or in addition, the measurement deviation can be locally determined along the region boundary on the basis of the error in a position determination. The measurement deviation can be locally determined along the region boundary of the established monitoring region on the basis of the predetermined technical data. Alternatively or in addition, the measurement deviation can be locally determined along the region boundary of the established monitoring region on the basis of the empirical test.

According to an embodiment, in the step of locally adjusting the region boundary of the established monitoring region, the adjusted monitoring region can comprise a polygon. The polygon can be adjusted in line with the determined measurement deviation for the at least one measurement value. The polygon can span a certainty region around the established monitoring region, wherein an object detected in this certainty region by the environment detection sensor system is assigned to the established monitoring region on the basis of the locally determined measurement deviation. A distance of the polygon in relation to the established monitoring region or a distance of a region boundary of the adjusted monitoring region in relation to the region boundary of the established monitoring region can vary locally. The local varying of the distance can be based on measurement deviations locally determined independently of one another.

According to an embodiment of the method, in the step of locally adjusting the region boundary of the established monitoring region, the region boundary can be locally extended on the basis of the locally determined measurement deviation. The region boundary can be locally extended on the basis of the locally determined angle measurement error. Alternatively or in addition, the region boundary can be locally extended on the basis of the locally determined distance measurement error. The region boundary can be extended proportionately to the measurement deviation, for example by half of the measurement deviation.

According to an embodiment of the method, the latter can comprise, as a further step, locally establishing a measurement error region for the at least one measurement value of the environment detection sensor system on the basis of the locally determined measurement deviation. The locally established measurement error region can be spanned on the basis of the locally determined angle measurement error. Alternatively or in addition, the locally established measurement error region can be locally spanned on the basis of the locally determined distance measurement error. For example, the measurement error region can be a measurement error ellipse spanned on the basis of the angle measurement error and the distance measurement error. The measurement error ellipse can be a confidence interval of a corresponding measurement uncertainty.

According to an embodiment, in the step of locally adjusting the region boundary of the established monitoring region, the region boundary can be locally extended on the basis of the locally established measurement error region. The established measurement error region can be extended by a subregion of the locally established measurement error region which protrudes from the established monitoring region.

In an aspect, the invention relates to a system for detecting an object in the environment of a vehicle. The system has an environment detection sensor system which is able to be arranged on the vehicle. The environment detection sensor system can be the environment detection sensor system described in relation to the preceding aspect. The system additionally has a computing unit which is configured to establish a monitoring region in a detection region of the environment detection sensor system in order to monitor the environment of the vehicle for an object residing in the monitoring region.

The computing unit is configured to locally determine a measurement deviation for at least one measurement value of the environment detection sensor system in the established monitoring region. The computing unit is additionally configured to locally adjust a region boundary of the established monitoring region in line with the locally determined measurement deviation in order to monitor the environment of the vehicle for an object residing in the adjusted monitoring region.

In an aspect, the invention relates to a vehicle which has an environment detection sensor system. The vehicle additionally has the system according to the preceding aspect. The vehicle, the environment detection sensor system, and the system can be designed as described in relation to the preceding aspects.

Embodiments and features of one aspect of the invention can form corresponding embodiments and features of another aspect of the invention. The system can have corresponding system components which can be configured to carry out the method steps described in relation to the method.

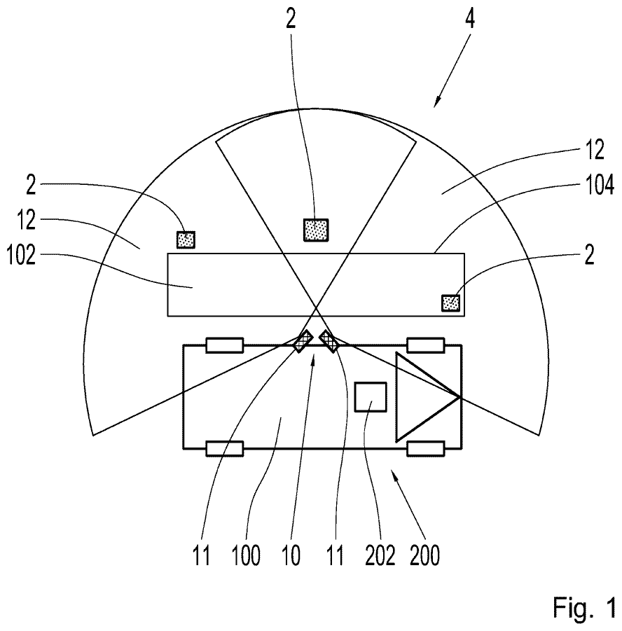

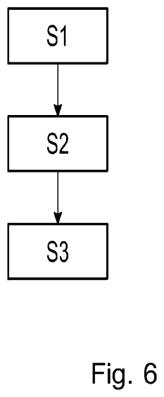

FIG. 1 shows a vehicle 100. The vehicle 100 has a system 200 which has an environment detection sensor system 10 and a computing unit 202. The computing unit is configured to carry out the method steps shown in FIG. 6.

The environment detection sensor system 10 has two detection sensors 11 in the exemplary embodiment shown in FIG. 1. The detection sensors 11 have a respective detection region 12 which form a collective detection region 12 of the environment detection sensor system 10. An object 2 residing in the environment 4 of the vehicle 100 is detected in the detection region 12 by the environment detection sensor system 10. In this case, the object 2 resides in the detection region 12. Relative to the vehicle 100, a monitoring region 102 is established in the environment 4 and the detection region 12. In the exemplary embodiment shown in FIG. 1, the monitoring region 102 is established at a distance from a vehicle longitudinal axis of the vehicle 100 or laterally to the vehicle 100. The monitoring region 102 has a region boundary 104 inside of which an object 2 is able to be detected by the environment detection sensor system 10. The environment detection sensor system 10 is used to monitor the monitoring region 102 for an object 2 residing in this region.

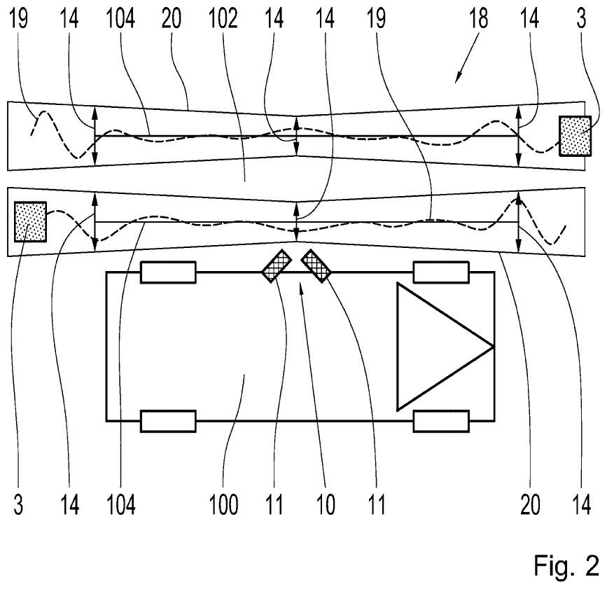

In FIG. 2, when an object 2 is detected by the environment detection sensor system 10, a measurement deviation 14 is locally determined on the basis of an empirical test 18. In the empirical test 18, a test object 3 is moved along the region boundary 104. In the exemplary embodiment shown in FIG. 2, the test object 3 is moved along at least one region boundary 104 running in a main direction of extent of the monitoring region 102. In this case, the test object 3 is moved relative to the vehicle 100 which is stationary during the empirical test 18. The environment detection sensor system 10 detects an object trajectory 19 of the test object 3, which trajectory locally deviates from the course of the region boundary 104. A local measurement deviation 14 is determined locally on the basis of a deviation of the detected object trajectory 19 from the region boundary 104. The locally determined measurement deviations 14 vary along the region boundary 104 at least in dependence on a measurement distance of the environment detection sensor system 10 during the detection of the test object 3.

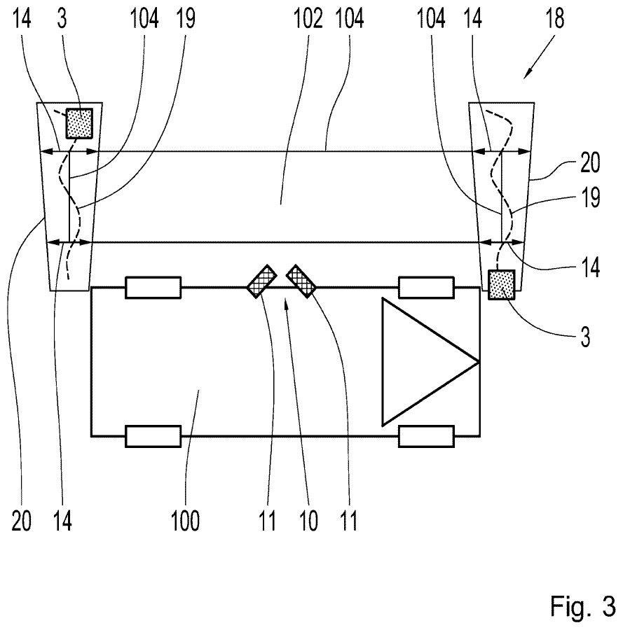

In the exemplary embodiment shown in FIG. 3, the test object 3 is moved along a particular region boundary 104 which runs in a secondary direction of extent of the monitoring region 102. The locally determined measurement deviations 14 vary along the region boundary 104 as distance increases during detection of the test object 3 by the environment detection sensor system 10. In FIGS. 2 and 3, the measurement deviations 14 span measurement error regions 20 along the region boundaries 104, which measurement error regions comprise the locally determined measurement deviations 14. A width of the measurement error regions 20 varies locally. The measurement error regions 20 are polygonally spanned regions, wherein the measurement error regions 20 have boundaries which do not run parallel to the region boundary 104 of the monitoring region 102.

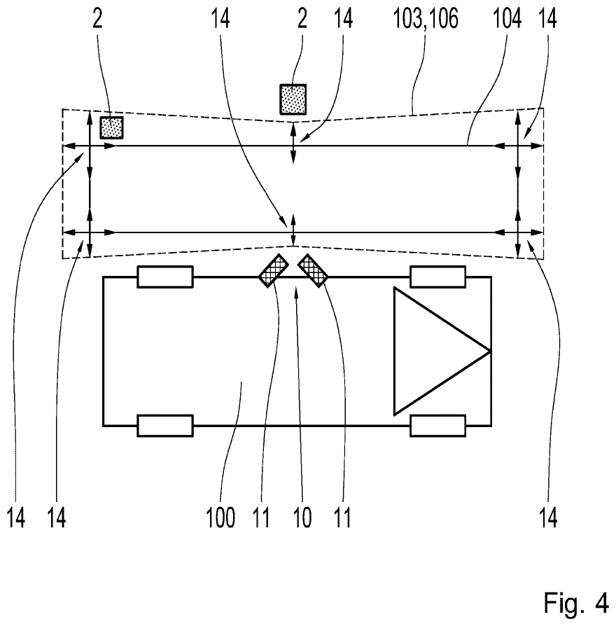

FIG. 4 shows a monitoring region 103 adjusted in line with the locally determined measurement deviations 14. The adjusted monitoring region 103 is extended by the locally determined measurement deviations 14. The locally determined measurement deviations 14 span a polygon 106 which forms a region boundary of the adjusted monitoring region 103. An object 2 residing within the region boundary of the adjusted monitoring region 103 is assigned to the monitoring region 102 on the basis of the locally determined measurement deviations 14. An object 2 detected not to be within the adjusted monitoring region 103 is not assigned to the monitoring region 102.

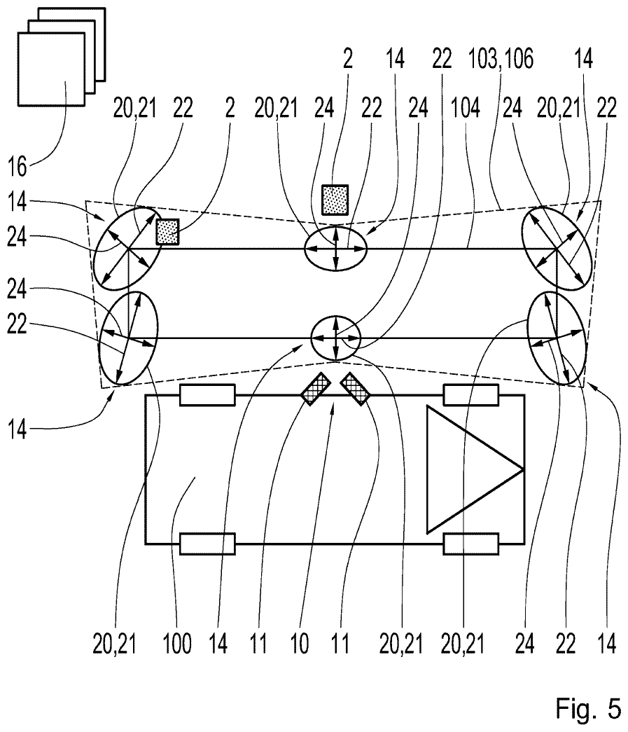

According to an embodiment, FIG. 5 shows locally determined measurement deviations 14 and a locally adjusted region boundary 104 of the established monitoring region 102 adjusted in line with the locally determined measurement deviations 14. The measurement deviations 14 are read or determined from technical data 16. Angle measurement errors 22 and distance measurement errors 24 are determined locally along the region boundary 104 of the monitoring region 102 from the technical data 16. The corresponding errors are locally determined at bends of the polygon 106. The angle measurement errors 22 and distance measurement errors 24 span error ellipses 21 as measurement error regions 20 along the region boundary 104. The measurement error regions 20 in turn span a polygon 106 which forms the region boundary of the locally adjusted monitoring region 103.

FIG. 6 schematically shows a flowchart of method steps S1 to S3 of a method for detecting an object 2 in the environment 4 of the vehicle 100 by way of the environment detection sensor system 10 arranged on the vehicle 100. The method is carried out by the system 200. In a first step S1, the monitoring region 102 in the detection region 12 of the environment detection sensor system 10 is established. In a further step S2, a measurement deviation 14 of the environment detection sensor system 10 is locally determined in the established monitoring region 102. In a further step S3, the region boundary 104 of the established monitoring region 102 is adjusted in line with the locally determined measurement deviation 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

2 object
3 test object
4 environment
5 environment detection sensor system
11 detection sensor
12 detection region
14 measurement deviation
16 technical data
18 empirical test
19 detected object trajectory
20 measurement error region
21 error ellipse
22 angle measurement error
24 distance measurement error
100 vehicle
102 monitoring region
103 adjusted monitoring region
104 region boundary
106 polygon
200 system
202 computing unit
S1 establish monitoring region
S2 determine measurement deviation
S3 adjust region boundary

1: A method for detecting an object in the environment of a vehicle by way of an environment detection sensor system arranged on the vehicle, the method comprising:
establishing a monitoring region in a detection region of the environment detection sensor system in order to monitor the environment of the vehicle for an object residing in the monitoring region by way of the environment detection sensor system;
locally determining a measurement deviation for at least one measurement value of the environment detection sensor system in the established monitoring region; and
locally adjusting a region boundary of the established monitoring region in line with the locally determined measurement deviation in order to monitor the environment of the vehicle for the object residing in the adjusted monitoring region by way of the environment detection sensor system.

2: The method as claimed in claim 1, wherein, in the step of locally determining the measurement deviation, the measurement deviation is locally determined for the measurement value on the basis of an angle measurement error of the environment detection sensor system.

3: The method as claimed in claim 1, wherein, in the step of locally determining the measurement deviation, the measurement deviation is locally determined for the measurement value on the basis of a distance measurement error of the environment detection sensor system.

4: The method as claimed in claim 1, wherein, in the step of locally determining the measurement deviation, the measurement deviation is locally determined on the basis of predetermined technical data of the environment detection sensor system.

5: The method as claimed in claim 1, wherein, in the step of locally determining the measurement deviation, the measurement deviation is locally determined on the basis of an empirical test of the environment detection sensor system for detecting the object in the environment of the vehicle.

6: The method as claimed in claim 1, wherein, in the step of locally determining the measurement deviation, a measurement deviation for at least one measurement value of the environment detection sensor system is locally determined along the region boundary of the established monitoring region, and
in the step of locally adjusting the region boundary of the established monitoring region, the adjusted monitoring region comprises a polygon which is adjusted in line with the determined measurement deviation for the at least one measurement value.

7: The method as claimed in claim 1, wherein, in the step of locally adjusting the region boundary of the established monitoring region, the region boundary is locally extended on the basis of the locally determined measurement deviation.

8: The method as claimed in claim 1, further comprising locally establishing a measurement error region for the at least one measurement value of the environment detection sensor system on the basis of the locally determined measurement deviation,
wherein, in the step of locally adjusting the region boundary of the established monitoring region, the region boundary is locally extended on the basis of the locally established measurement error region.

9: A system for detecting an object in the environment of a vehicle, comprising:
an environment detection sensor system which is configured to be arranged on the vehicle;
a computer configured to establish a monitoring region in a detection region of the environment detection sensor system in order to monitor the environment of the vehicle for an object residing in the monitoring region,
wherein the computer is configured to locally determine a measurement deviation for at least one measurement value of the environment detection sensor system in the established monitoring region and locally adjust a region boundary of the established monitoring region in line with the locally determined measurement deviation in order to monitor the environment of the vehicle for the object residing in the adjusted monitoring region.

10: A vehicle comprising an environment detection sensor system and the system as claimed in claim 9.
